(19) United States
(12) Patent Application Publication
(10) Pub. No.: US 2022/0135435 A1
(43) Pub. Date: May 5, 2022

(54) DESALINATION APPARATUS WITH ELECTRICAL POWER GENERATION

(71) Applicant: Neal Howard Trantham, Orlando, FL (US)

(72) Inventor: Neal Howard Trantham, Orlando, FL (US)

(21) Appl. No.: 17/089,656

(22) Filed: Nov. 4, 2020

(51) Int. Cl. C02F 1/04; C02F 1/08; B01D 1/00; B01D 5/00

(52) U.S. Cl. CPC C02F 1/048; C02F 1/08; C02F 2103/08; B01D 1/0029; B01D 5/006; C02F 1/043

(57) ABSTRACT

An apparatus and method for treating brine water stored in tank batteries or otherwise produced during oil and gas production. The apparatus is portable and can be moved from one location to another to treat the brine water. Once the apparatus is in position, the brine water is pumped out of the tank and sprayed onto heating plates to produce steam. The brine water not evaporated by the plates is collected and filtered, and any precious metals or valuable minerals may be extracted therefrom. Steam generated from the heating process may be used to power an electrical generator, which generator may provide electrical power to operate the apparatus.

### RELATED APPLICATIONS

This application claims priority to U.S. Prov. Application No. 62/930,204 filed on Nov. 4, 2019.

### FIELD OF THE INVENTION

The present invention relates to desalination machines. More specifically, the invention relates to a desalination apparatus which can generate and store electrical power while also providing purified water.

### BACKGROUND OF THE INVENTION

Management and disposal of produced water is one of the most important problems associated with oil and gas (O&G) production. O&G production operations generate large volumes of brine water (produced water) along with the petroleum resource. Currently, produced water is treated as waste and is not available for any beneficial purposes for the communities where oil and gas are produced. Produced water contains different contaminants that must be removed before it can be used for any beneficial surface applications. Accordingly, it would be advantageous to provide a method for treating produced water, especially for produced water stored in tank batteries associated with O & G production.

Water desalination are known; however, the applicant is not aware of any other plants or similarly applicable inventions that present technical characteristics similar to the ones presented by the one recited herein.

In this regard, it is to be noted that many methods for separating water from salts have been reviewed, starting with reverse osmosis, which is the one most widely implanted throughout the world recently, with large energetic costs and facility investments, and ending with flash-effect distillation, which is the one desalting the largest amount of water, although it is associated with small facilities as well as large energetic costs. The above-mentioned proposals resort to conventional energy sources, which makes them expensive to operate.

Based on renewable energies there are those that, on the one hand, take their energy from hydrothermal sources or waste energy in facilities such as thermoelectric plants and those resorting to sunlight or the wind.

### SUMMARY OF THE INVENTION

An apparatus and method for treating brine water stored in tank batteries or otherwise produced during oil and gas production. The apparatus is portable and can be moved from one location to another to treat the brine water. Once the apparatus is in position, the brine water is pumped out of the tank and sprayed onto heating plates to produce steam. The brine water not evaporated by the plates is collected and filtered, and any precious metals or valuable minerals may be extracted therefrom. Steam generated from the heating process may be used to power an electrical generator, which generator may provide electrical power to operate the apparatus.

The invention concerns, in a second aspect, a seawater, brine or sewage solar desalination method.

The invention pertains to the technical field of water treatment by desalination and evaporation using infrared energy. In particular, it allows the desalination of brine, contaminated water, seawater and the recovery of usable salt, minerals, and other chemicals.

Since external conditions—irradiation, air and captured water temperatures—are variable throughout the day and in the different days of varying years, obtaining maximum performance with one single working regime—air and water flow rates, pressure and temperature regime—is unthinkable. Thereby, a computerized control system is proposed that, capturing the values of the variables and the performance at all times, will build the mathematical functions on empirical data so as to determine the linkage among the variables and will look for the relative maximums to optimize performance in every case—statistical adjustment methods by least squares and widespread linear and non-linear models. It would be a continuously self-learning system.

It is a major object of the invention to provide a desalination apparatus which can generate and store electrical power.

It is another object of the invention to provide a desalination apparatus which uses infrared heating.

It is another object of the invention to provide a desalination apparatus which produces steam to power an electrical generator.

It is another object of the invention to provide a desalination apparatus which can be used to produce salt and metal ores.

It is another object of the invention to provide a desalination apparatus which is portable.

### BRIEF DESCRIPTION OF THE DRAWINGS

FIG. 1 shows a diagrammatic illustration of the inventive apparatus of the invention.

### DETAILED DESCRIPTION

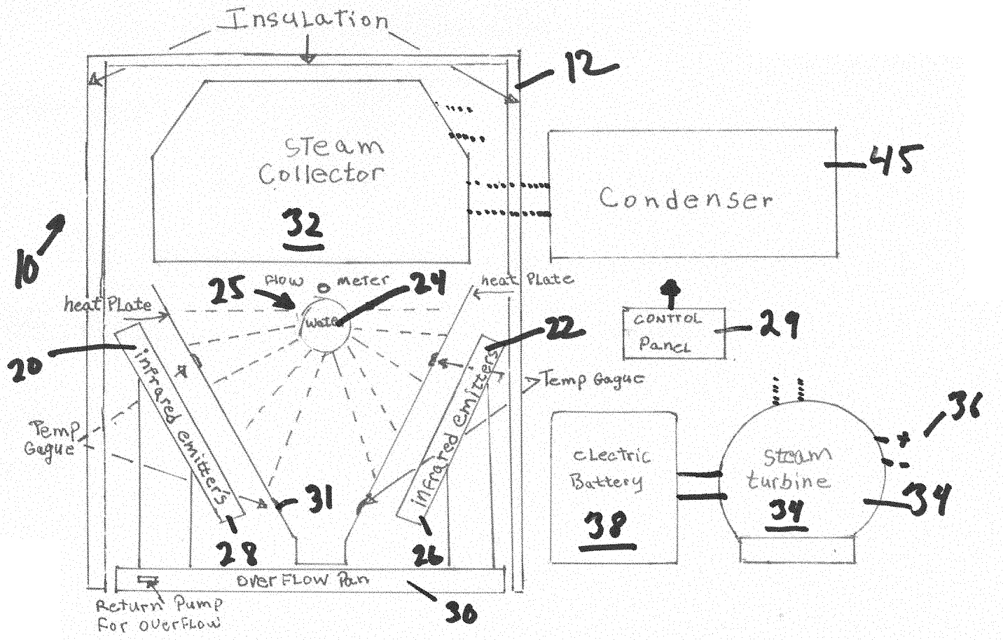

The inventive apparatus, generally indicated by the numeral 10, is shown in FIG. 1. The apparatus 10 uses heat to generate steam, which steam can then be collected as 99% pure water to be used for any purpose. The apparatus 10 has particular utility in an oilfield where there is saltwater or brackish in reserve pits or storage tanks. In accordance with one aspect of the invention, the apparatus 10 is portable and may be used to pump water from, e.g., multiple storage tanks, and onto the apparatus 10 for processing in the manner described below.

In accordance with one aspect of the invention, the apparatus 10 is moved from one tank in the oilfield to another, and thus is preferably sized and configured to be reasonably portable. The apparatus 10 can then be moved from tank to tank to treat all the tanks in an oilfield and may be disassembled and used at another oilfield. The apparatus 10 is housed in an insulated housing 12 to reduce thermal transients which may interfere with the operation of the apparatus.

An angled pair of opposing heat plates 20, 22 are positioned to receive water spray from a flow regulator or nozzle 24 with a dispersion pattern sufficient to uniformly contact the heat plates=20, 22 surface and produce a constant rate of steam while allowing very little of the salt water to remain untreated. The nozzle 24 is connected to a conduit 25 which receives the water to be treated. The saltwater to be treated is collected from reserve pits and tank batteries (not shown) as would ordinarily appear in a typical oilfield operation. The spray rate and dispersion, as well as the surface area and optimal temperature of the plates 20, 22 must be calculated to maximize the efficiency of the apparatus 10, which calculations would be apparent to one of skill in the art. The nozzle 24 can adjust the spray pattern by way of a microprocessor-controlled flow regulating mechanism as would be apparent to one of skill in the art. A control panel 29 may be electrically connected to control the operation of the nozzle 24 either manually or by software control. The control panel 29 is preferably connected (either wired or wirelessly) to control all electronically operable components of the apparatus 10 including the heating plates 20, 22 and emitters 26, 28. The plates 20, 22 are heated by infrared emitters 26, 28 which are positioned in thermally conductive relation to the plates. Each plate 20, 22 includes a temperature sensor 31, the sensors 31 forming part of a control loop, the control loop using temperature data from the sensors 31 to adjust the output of the emitters 26, 28 as would be apparent to one of skill in the art.

Water and other non-liquid precipitate can accumulate in the catch basin 30 which is positioned beneath the angled plates 20, 22. The precipitate will be mostly salt, but may also include metal ores or valuable minerals, all of which may be collected and processed. The steam generated from the heating process is collected by collector 32 which may include a condenser 45 to produce liquid water. Some or all of the steam generated may be diverted to a steam turbine 34 which can produce an electrical output at terminals 36 and therefore function as an electrical generator. The turbine 34 may be electrically connected to a battery 38, which it periodically charges, preferably the charging is done under microprocessor control so as not to damage the battery. The battery 38 may be used to power the infrared emitters as well as some of the control systems of the apparatus 10. Indeed, some of the electrical power generated may be used to power the apparatus 10, for example to provide some or all of the power needed for infrared emitters 26, 28.

The desalination of brackish or residual waters, is the tool that can presently allow obtaining fresh water, the only limitation being the energy required to separate the water from the minerals, chemicals, and salt contained therein. This is currently done with the technique of reverse osmosis or other procedures that involve large economic expense because of the required amount of energy and the cost of the facilities.

Taking into account that fresh water is more necessary where there is also the greatest insolation, the system being proposed is based on the exploitation of infrared heat and allows for the exploitation of the insolation to vaporize and distil water. Another of its advantages is that the energy expenditure is extremely low, since most of the necessary energy comes from generators that are attached to the device (except for a small amount of electric energy for the general operation of the system, which can also come from other sources).

Specifically, the desalination plant advocated by the invention consists of a plurality of metal plates between 30 and 60 degrees from horizontal by a support structure. The structure can be designed to be portable by a single user, vehicle, or permanently installed on a site. Those of skill in the art can select individual components that are needed to meet the design requirements.

The angle of the metal plates of said structure allows for the high temperatures are provided therein that allow for the vaporization of the brackish or contaminated water injected onto the plates as a spray or small drops. This gives rise to humidity-laden air that is drawn to a condensation column and steam powered electrical generator. With the objective of having a closed circuit of air that will allow its circulation with one single compressor, there is a smaller closed tank inside a larger one that comprises a network of tunnels and storage of a surplus of water and its corresponding frigories for the dissipation of heat and the condensation of vapors. A drip cock transfers the water produced in the small tank towards the tunnels.

Along the path of the seawater that is to be blown in, it has gone through a vertical tube inside the condensation column that transports the air-vapor mixture countercurrent, thereby permitting the latter's condensation in the form of fresh water through a heat exchanger: humid air-seawater; the input salt water has been heating up. Circulation is always countercurrent. On the spots where the temperature to be dissipated is higher, the temperature of the collecting element is higher, and vice versa. This way, the efficiency of the calorie recovery process is ensured.

In turn, the partially cooled off air and part of its condensed water load reach the previously mentioned tank, wherein it cools off even further as a result of the latter's being in the subsoil, which always maintains lower temperature (coldest spot of the entire process).

The maximum condensation of the contained water occurs in this point. This air returns to the top, where it progressively heats up while, at the same time, it favors the condensation of the humid air circulating in the opposite direction along a stretch, also with a heat exchanger and countercurrent once again.

The chemicals are collected in the lower areas of the device as they slide of the metal plates. The metal plates may be constructed of ay material, however, stainless steel in preferred.

The invention also contemplates the incorporation of a computerized process control that will assess variables at all times so as to optimize the performance; all of it using statistical techniques of data collection and the adjustment of complex equations by least squares and widespread linear and non-linear models in a process that can be described as ‘self-learning’ by the system itself.

The system controls are flow rate of the air and the nebulized water, facility operation regime. These are assessed and modified (monitored) so as to reach the topmost performance in every case.

The plant enclosure may have various configurations, among them said quadrangular pyramidal configuration including one single condensation-distillation column, or one configuration with at least a top portion in the elongated triangular dome including several spaced-apart condensations-distillation columns.

In view of the above, it is established that the described seawater, brine, or sewage solar desalination plant represents an innovative structure of heretofore-unknown structural and constitutive characteristics therefor, and with industrial scale results.

It is to be understood that the present invention is not limited to the sole embodiment described above, but encompasses any and all embodiments within the scope of the following claims:

I claim:

1. A desalination apparatus comprising:
a flow regulator for receiving a supply of liquid to be treated, said flow regulator capable of dispersing said liquid in accordance with a predetermined pattern and rate of flow;
a plurality of thermal plates for receiving said dispersed liquid, said thermal plates are heated sufficiently to vaporize most of said liquid upon impact of the liquid on said thermal plates;
a catch basin for receiving said liquid and any resulting precipitate;
a steam collector for receiving and processing steam from said plates;
a steam output from said steam collector which is used to power a turbine or wherein said steam output is sent to condenser wherein the steam from the steam output is converted into liquid water or wherein the steam output is sent to both the turbine and condenser.

2. The apparatus of claim 1 wherein said flow regulator is a nozzle.

3. The apparatus of claim 1 wherein the liquid is dispensed in a mist.

4. The apparatus of claim 1 wherein the liquid is dispensed in droplets.

5. The apparatus of claim 1 wherein said thermal plates are heated by infrared emitters.

6. The apparatus of claim 5 wherein the infrared emitters are located under the thermal plates.

7. The apparatus of claim 5 wherein the infrared emitters are location over the thermal plates.

8. The apparatus of claim 1 wherein said turbine produces electrical power.

9. The apparatus of claim 1 wherein said turbine is used to mechanically move a shaft.

10. The apparatus of claim 8 wherein said electrical power is used to power the infrared emitters.

11. The apparatus of claim 8 wherein said electrical power is used to charge a battery.

12. The apparatus of claim 5 wherein the thermal plates are heated to a temperature of at least two hundred degrees Celsius.

13. The apparatus of claim 5 wherein the thermal plates are heated to a temperature of at least three hundred degrees Celsius.

14. The apparatus of claim 1 wherein the condensers are air cooled.

15. The apparatus of claim 1 wherein the condensers are water cooled.

16. The apparatus of claim 1 wherein the device can be transported by an individual.

17. The apparatus of claim 1 wherein the device can be transported by a single vehicle.
